(19) United States
(12) Patent Application Publication
(10) Pub. No.: US 2007/0266050 A1
(43) Pub. Date: Nov. 15, 2007

(54) Method, Device and System for Extending a Mark-Up Language

(75) Inventor: Gerardus W.J. Kaandorp, Amsterdam (NL)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Backbase B.V.

(21) Appl. No.: 10/578,458

(22) PCT Filed: Nov. 8, 2004
(86) PCT No.: PCT/NL04/00785

§ 371 Date: Mar. 6, 2007

(30) Foreign Application Priority Data
Nov. 7, 2003 (NL) 1024745
Dec. 24, 2003 (NL) 1025125

(51) Int. Cl. G06F 17/30

(52) U.S. Cl. 707/200; 707/E17.118

(57) ABSTRACT

The present invention provides a method of rendering document data compliant with an KM-based mark-up language, comprising the steps of: fetching the document data) parsing the document data into a document object model (DOM) representation so as to provide a tree structure, comprising nodes representative of the document data elements including tags and/or attributes; reconstructing the document object model (DOM) representation by replacing the nodes of pre-specified elements of said document data elements by one or more nodes comprising standard XML compliant elements having standard tags and attributes; rendering the document data with the reconstructed document object model (DOM) representation.

The present invention relates to a method, device and system for functionally extending a mark-up language for rendering XML compliant document data. The invention also relates to a computer program for implementing the method on a computer.

All modern web browsers support two important technologies, namely plug-ins and scripting for extending functionality of the browser. With plug-in technology, it is possible to extend a browser's standard functionality by downloading and installing separate software. Scripting refers to the possibility to include software (scripting code) in HTML pages that will run inside the browser, within the scope of the currently loaded document. Scripting code may interact with the user and allows access to the contents of the document.

Currently, no standards exist to facilitate support for handling the extended functionality provided by custom tag behaviours in the standard mark-up languages. Some web browser development teams have created various incompatible solutions, often based on proprietary technology. For example, in Internet Explorer, version 5.5 and higher, custom tag and attribute behaviours are supported by means of HTML Component (HTC) files, which define the behaviour of (new) tags and attributes. This technology works only in later versions of Internet Explorer and derived browsers. For example, Mozilla and the recent versions of Mozilla-based browsers, such as Netscape Communicator, support the extensible Bindings Language (XBL), which is mainly used for declaring the behaviour of interface components created with XUL, the extensible User Interface Language. XUL is mostly used to describe the interface of the browser application itself, although it could also be used for-web pages. XBL could also be used to extend the standard set of tags that Mozilla-based browsers support. This technology works only in Mozilla-based browsers. As mentioned above web browsers support browser plug-in technology, which makes it possible to extend the browser's functionality by downloading and installing separate browser software components, and hence to achieve support for custom tag and attribute behaviours. This technology requires browser-specific plug-ins to be downloaded and installed once before a web page using custom tags/attributes may be visited. This prevents widespread use due to security considerations and the fact that installing plug-ins is often cumbersome.

Also is known to use Java programs (Java applets) that run inside a web browser. However, not all browsers support this technology. Besides, different implementations of the Java run-time environment exist for different web browsers and operating systems. In most cases, loading an applet causes the browser to pause a few seconds in order to start up the Java virtual machine program, which actually runs the Java program. To access the Document Object Model (DOM) tree of an XML document loaded into a web browser's memory, the applet would still have to call JavaScript functions. So while Java may provide a slightly more robust environment to support customised tag and attribute behaviours than JavaScript does, it is inconvenient for this purpose.

Finally methods are known for converting custom tags and/or attributes to standard tags or alter the behaviour of standard tags and attributes that use script code on the web server instead of the client computer. However, these methods require specific server technology, which cannot be deployed generically in different server environments since in practice server environments are incompatible. Therefore in existing server environments proprietary solutions are applied for custom tag and attribute behaviours.

A further drawback of deploying server-side technology is that it consumes valuable resources such as server-side CPU, I/O and most importantly, the bandwidth between server and client.

The object of the invention is, for documents based on the XML standard, such as XHTML, without the use of any technology not available by default in the majority of modern web browsers, to facilitate usage of non-standard, or custom tags, to facilitate usage of non-standard, or custom, attributes to existing tags, and/or to control the behaviour of standard tags and attributes.

US 2003/126556 A1 discloses a method for transforming XML document data into data objects. The method involves importing the XML document data, parsing the XML document data, and building a DOM tree from the parsed document data. The DOM tree however is used to construct at least one dynamic data object or one extended dynamic object so as to provide a transformation bridge connecting the XML world and the object world. The known method fails to disclose the functional extension of an XML compliant mark-up language so that the document data can be rendered by a standard browser.

According to a first aspect of the present invention a method is provided of rendering document data compliant with an extended XML-based mark-up language, comprising the steps of:

fetching the document data;

parsing the document data into a document object model (DOM) representation so as to provide a tree structure, comprising nodes representative of the document data elements including tags and/or attributes;

reconstructing the document object model (DOM) representation into a reconstructed document object model (DOM) representation by replacing the nodes of pre-specified elements of said document data elements by one or more nodes comprising standard XML compliant elements having standard tags and attributes so as to functionally extend said XML-compliant mark-up language;

rendering the document data with the reconstructed document object model (DOM) representation.

The document data elements can be standard elements, i.e. elements having standard tags and standard attributes that are pre-defined in some XML compliant standard mark-up language. These standard elements are known to many renderers and therefore can be handled by most of them. The phrase “standard element” used herein also includes proprietary elements, i.e. tags and attributes that are not defined in any of the (X)HTML compliant standard mark-up languages, but are supported only by specific renderers (cf. specific web browsers). The present invention enables the rendering of document data containing proprietary elements by a wide variety of renderers, not necessarily being renderers that are designed for handling those specific proprietary tags and/or attributes.

The document data elements can be custom elements as well, i.e. elements having tags or attributes unknown to the existing renderers. Custom elements are not pre-defined in any XML compliant standard mark-up language and therefore cannot be handled properly by any standard renderer.

The document data may also comprise a combination of one or more standard elements and one or more custom elements.

In a preferred embodiment the pre-specified elements are elements with standard tags and/or attributes providing a given functionality, the pre-specified elements being replaced by standard XML compliant elements having one or more different tags and/or attributes providing a modified functionality. This enables the standard behavior of standard tags and attributes to be modified, if needed. This might for instance be the case when new functionalities are to be introduced in existing document data.

In another preferred embodiment the pre-specified elements are elements with custom tags and/or custom attributes, the pre-specified elements being replaced by standard XML compliant elements having standard tags and/or attributes. This enables the possibility of an almost unlimited extension of the functionality offered by any XML based mark-up language.

It is to be understood that the reconstructed document object model representation may be rendered directly, without any intermediate steps, such as converting the document object model representation back into an XML compliant file and then rendering the file in a browser.

In a further preferred embodiment the method comprises the steps of:

reconstructing the document object model (DOM) representation by replacing a subset of the pre-specified elements of said document data elements by one or more nodes having standard XML compliant elements with standard tags and attributes,

rendering the document data with the reconstructed document object model (DOM); and

only upon triggering reconstructing the document object model (DOM) representation by replacing the remaining pre-specified elements of said document data elements by one or more nodes comprising standard XML compliant elements with standard tags and attributes.

In this embodiment the tree structure is alive. This means that the tree structure is constantly checked and, if needed, changed while the document is being rendered, for exampled displayed on a computer screen. Only when needed, i.e. when a user action or an external event from the server requires it, the intermediate elements are replaced by the standard elements that actually control the behavior. In this way a run-time control of behavior may be accomplished. Run-time as defined here is meant to express the time during which the XML based document is actually displayed on the screen of the client computer or, in other words, the time during which the user may interact with the document.

In a still further embodiment at least one node of a pre-specified element of said document data elements is replaced by one or more nodes with intermediate custom elements. Only upon triggering, i.e. by detecting a certain specific event, for example a user action or an external event from the server, the further step is performed of reconstructing the document object model (DOM) representation by replacing of the at least one node of the at least one intermediate custom element by one or more nodes comprising standard elements having standard tags and attributes.

In a further preferred embodiment the parsing step comprises parsing the document data into a document object model (DOM) representation so as to provide a tree structure, comprising one or more nodes representative of standard XML compliant elements with predefined standard tags and/or attributes and one or more nodes representative of custom elements with one or more custom tags and/or one or more custom attributes; and the reconstructing step comprises reconstructing the document object model (DOM) representation by replacing the nodes of custom elements by one or more nodes comprising standard elements.

This includes the case wherein custom attributes in standard tags are handled. The software developers will in this case be able to make use of the knowledge they already have about the standard XML based mark-up language that is to be extended by the invention.

According to a second aspect of the present invention a device is provided for rendering document data compliant with an extended XML-based mark-up language, the document data being stored on a remote server and accessible through a network, the device comprising:

an interface for retrieving the XML compliant document data from the server;

a parser for parsing the document data into a document object model (DOM) representation so as to provide a tree structure, comprising nodes representative of the document data elements including tags and/or attributes;

a reconstructor for reconstructing the document object model (DOM) representation into a reconstructed document object model (DOM) representation by replacing the nodes of pre-specified elements of said document data elements by one or more nodes comprising standard XML compliant elements having standard tags and attributes;

a renderer for rendering the document data with the reconstructed document object model (DOM) representation.

According to a third aspect of the present invention a system is provided for rendering XML compliant document data, comprising a host computer on which the XML compliant document data are stored, a client computer, and a network connecting the host computer and client computer, wherein the client computer comprises:

a network interface for retrieving the XML compliant document data from the host computer;

a parser for parsing the retrieved document data into an object model (DOM) representation so as to provide a tree structure, comprising nodes representative of the document data elements including tags and/or attributes;

a reconstructor for reconstructing the document object model (DOM) representation into a reconstructed document object model (DOM) representation by replacing the nodes of pre-specified elements of said document data elements by one or more nodes comprising standard XML compliant elements having standard tags and attributes;

a renderer for displaying the document data with the reconstructed document object model (DOM) representation.

According to a further aspect of the invention a data carrier is provided, for example an optical disk, hard disk, etc., that contains a recorded computer program product upon whose execution by a processor the method as disclosed herein is carried out.

According to a still further aspect of the invention a computer program is provided for carrying out, when run on a computer, for example a server computer or, preferably, a client computer, the steps of the methods as disclosed herein.

Further advantages, features and details of the present invention will be elucidated on the bases of the following description of some preferred embodiments thereof. Reference is made in the description to the figures, in which:

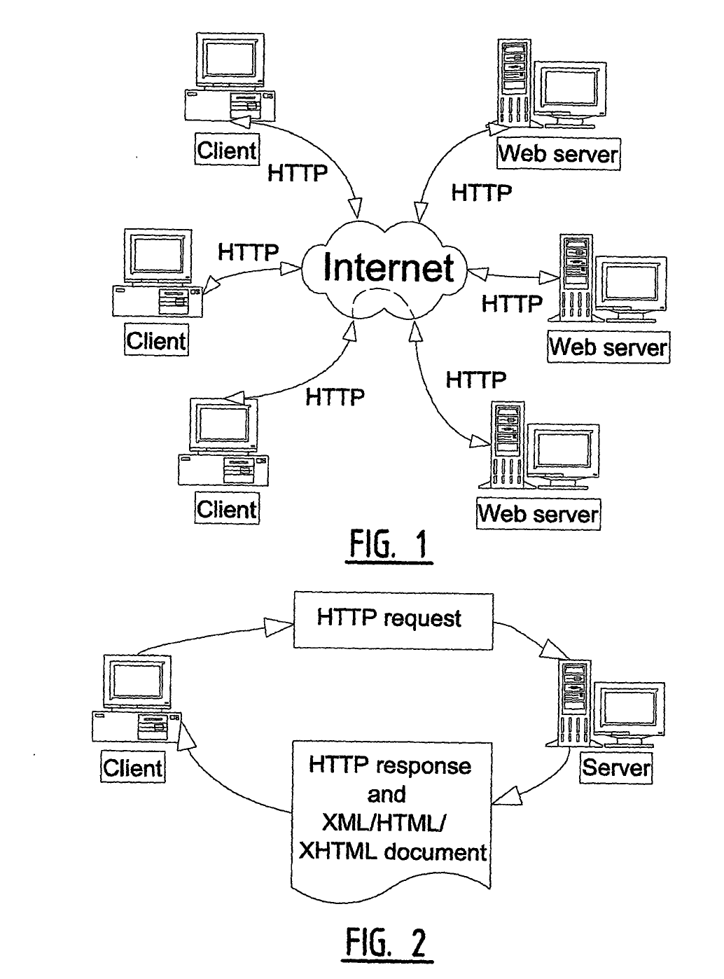

FIG. 1 is a schematic representation of the world-wide-web topography;

FIG. 2 is a schematic representation of HTTP client/server communication;

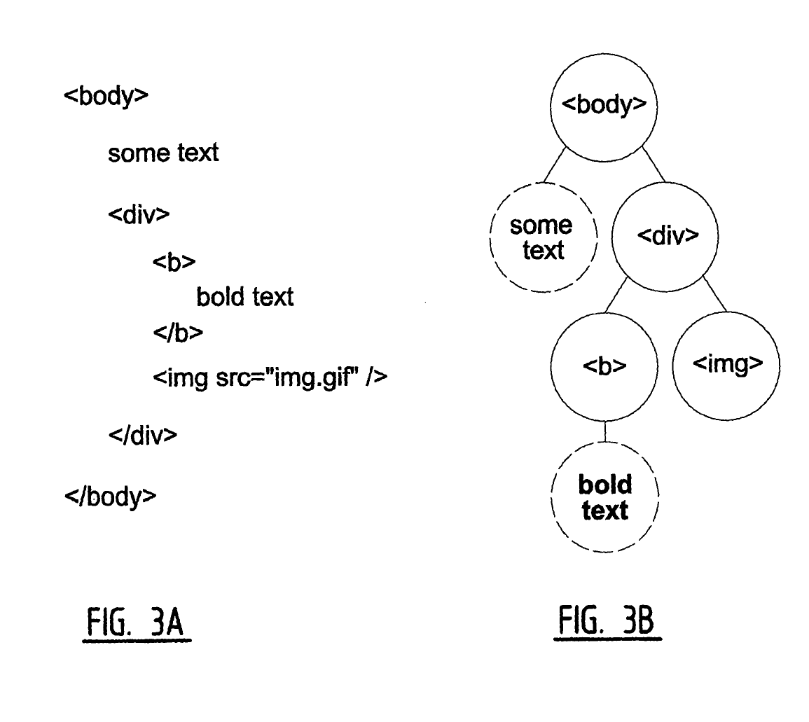

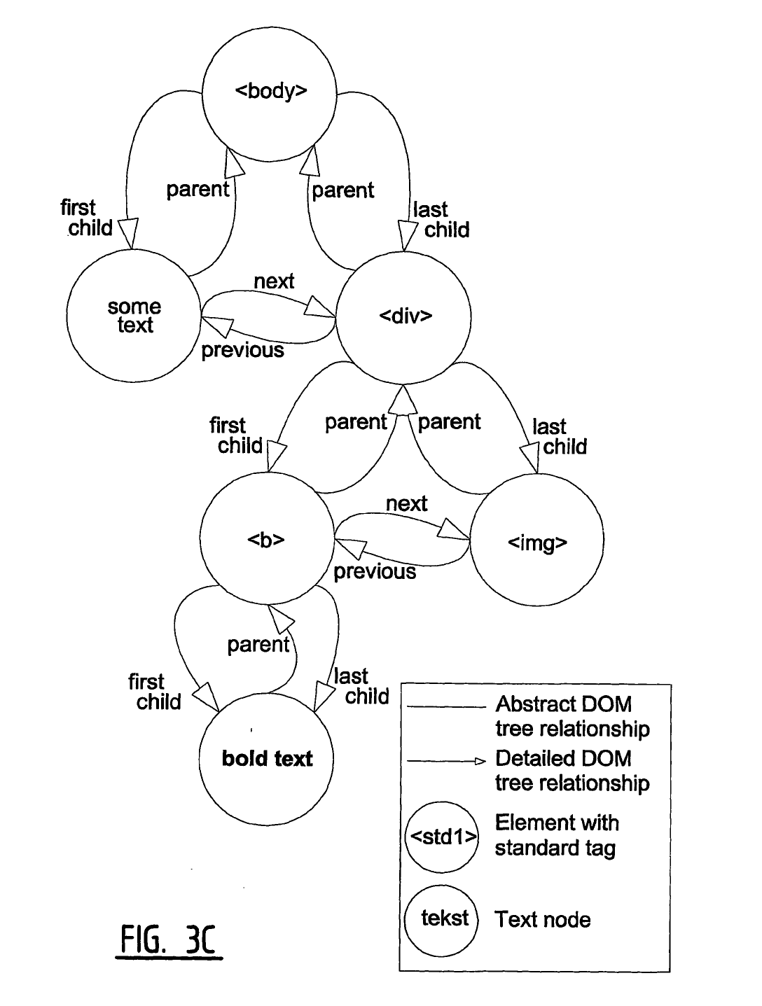

FIG. 3a shows an example of (X)HTML code;

FIG. 3b is a schematic representation of the DOM tree corresponding to the (X)HTML code of FIG. 3a;

FIG. 3c is a schematic representation of the DOM tree, showing the relations between the nodes of the tree;

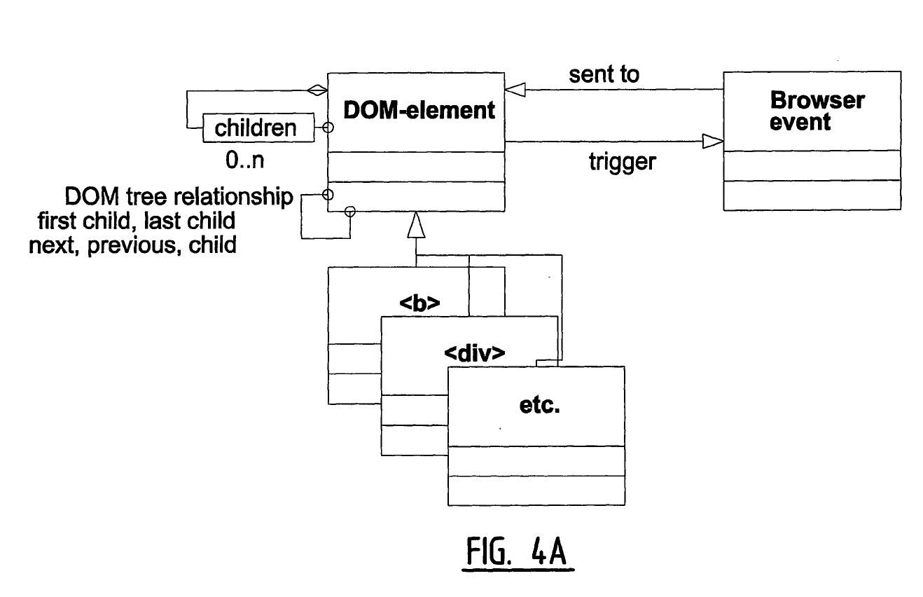

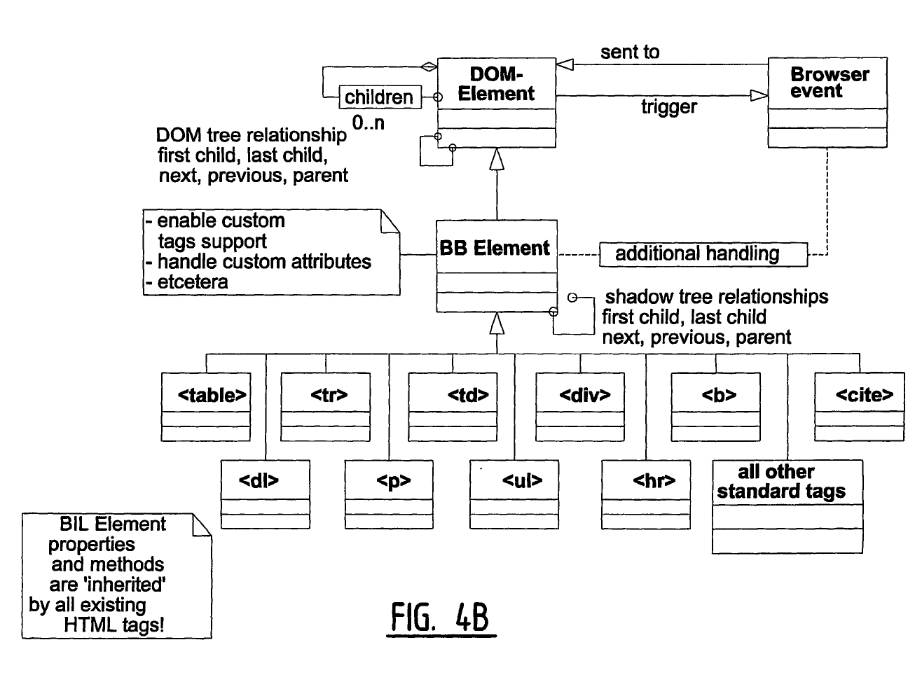

FIG. 4a shows the conceptual OMT model of the Document Object Model (DOM) representation;

FIG. 4b shows the conceptual OMT model of a revised Document Object Model (DOM) representation;

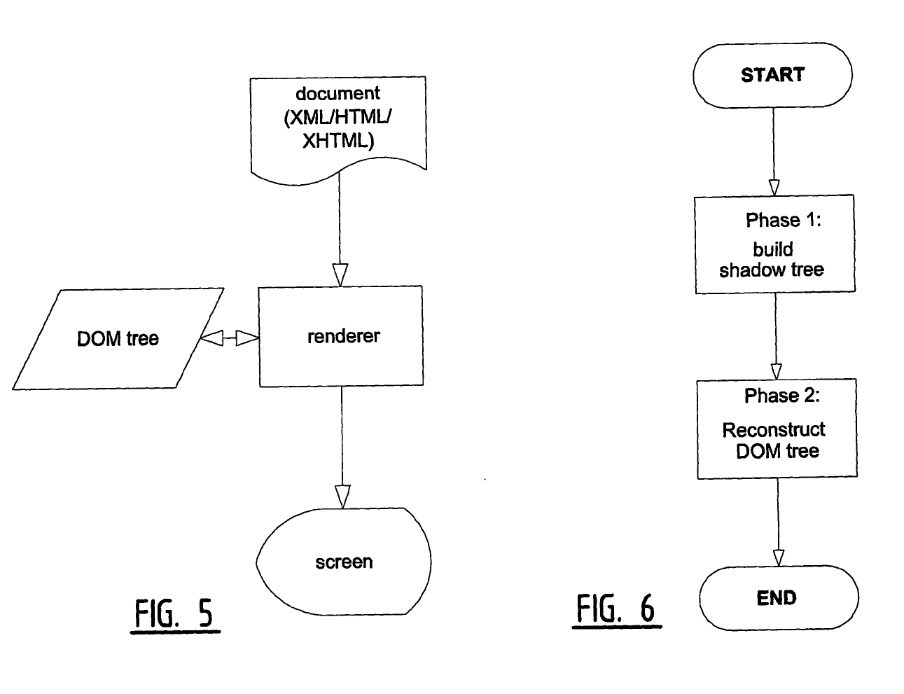

FIG. 5 is a flow diagram of the rendering by the client computer of XML compliant document data.

FIG. 6 is a flow diagram showing the building of the shadow tree;

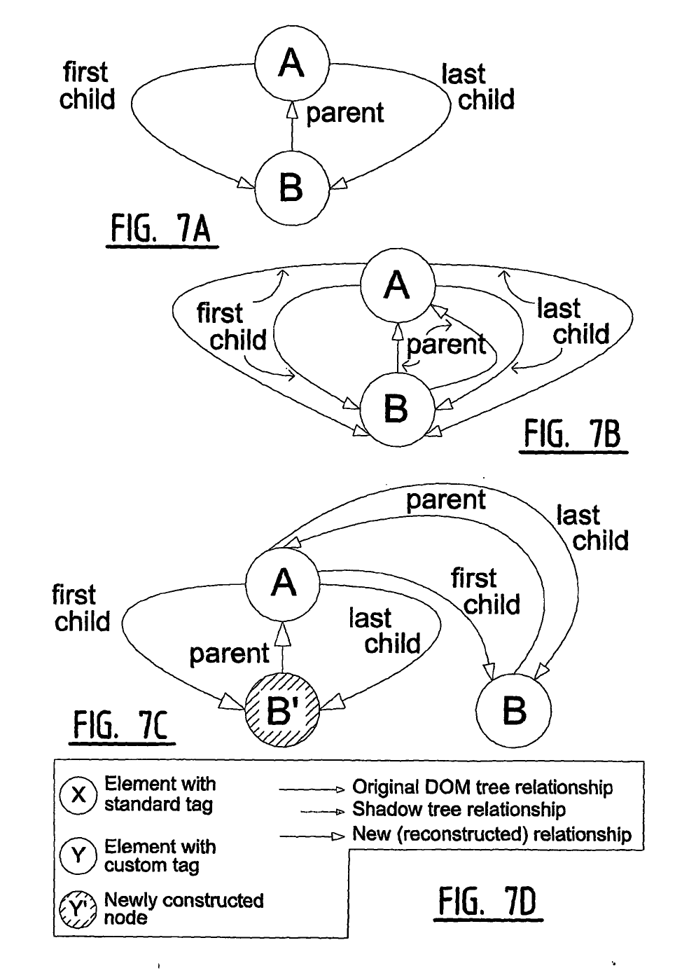

FIGS. 7a-7b are schematic representations showing the construction of a shadow tree;

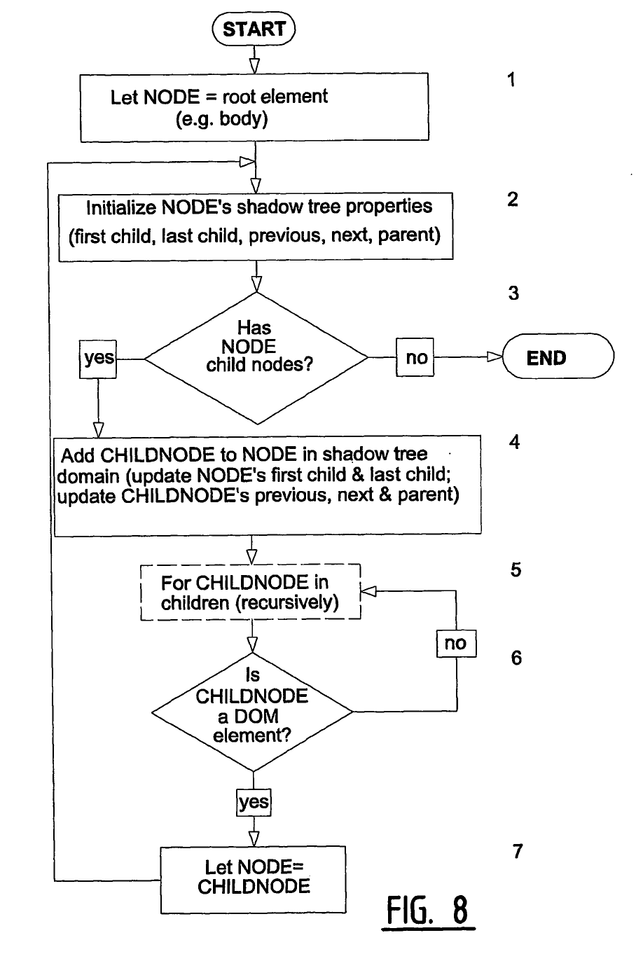

FIG. 8 is a flow diagram showing the constructing phase of the shadow tree;

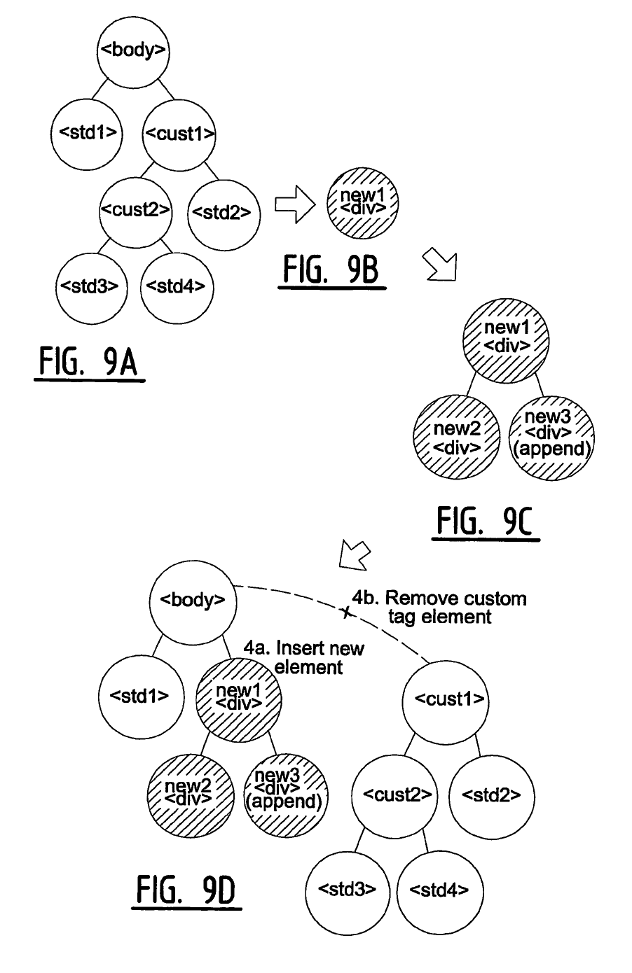

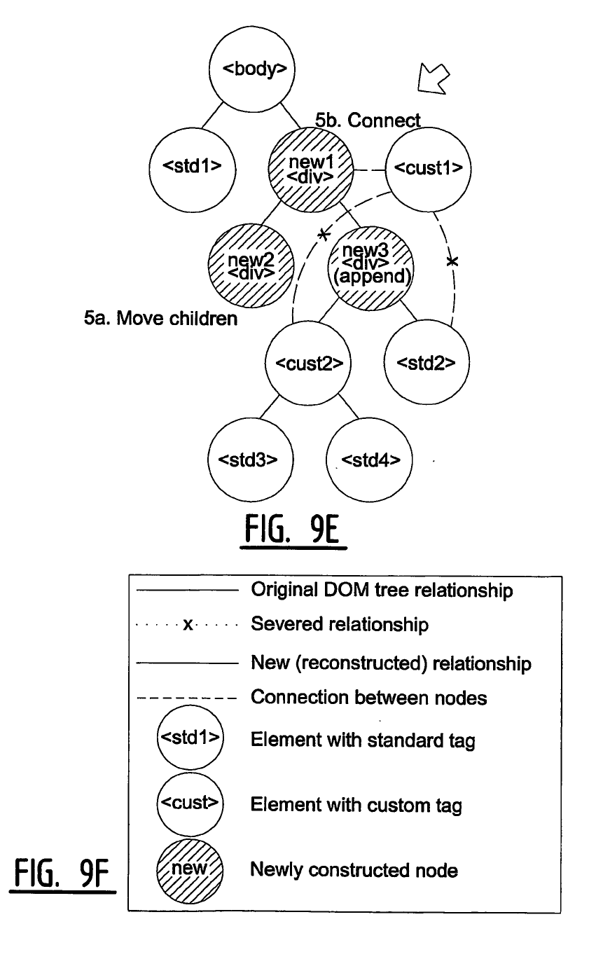

FIG. 9a shows an example of an original DOM tree;

FIG. 9b show the creation of a new element;

FIG. 9c shows the addition of extra nodes;

FIG. 9d shows the insertion of the new element and the removal of the element with the custom tag;

FIG. 9e shows the movement of children to new element's append node;

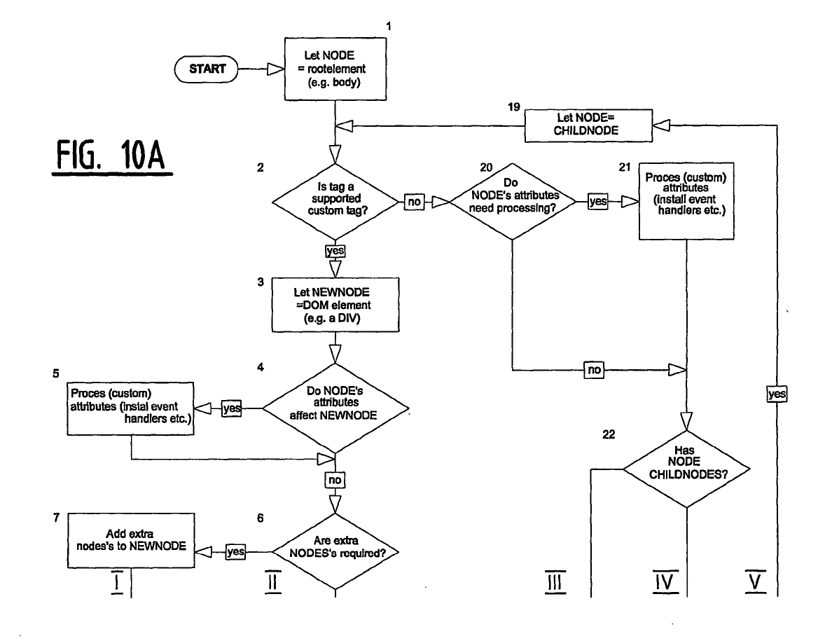

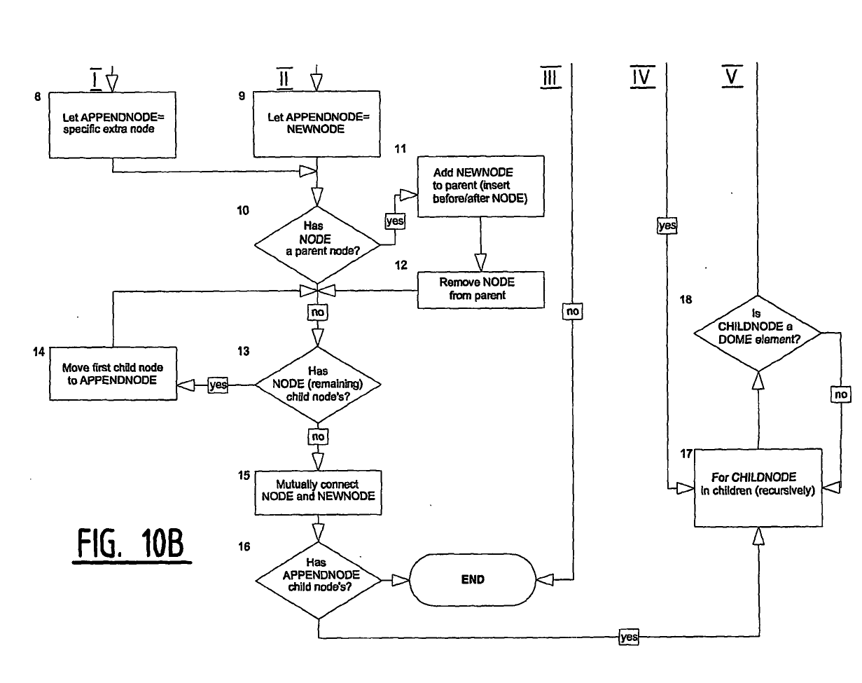

FIG. 10 is a flow chart showing the reconstructing phase of the DOM representation;

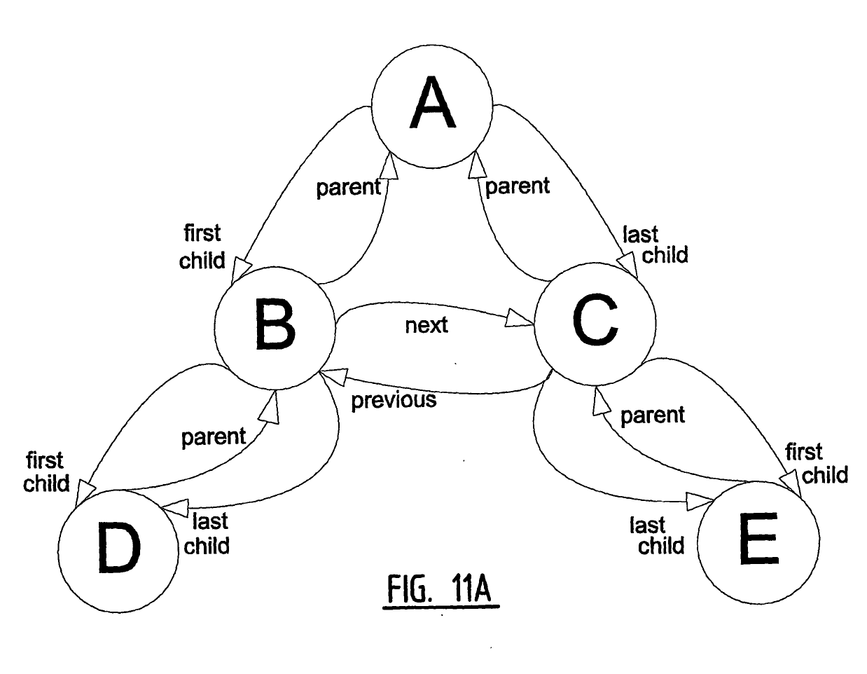

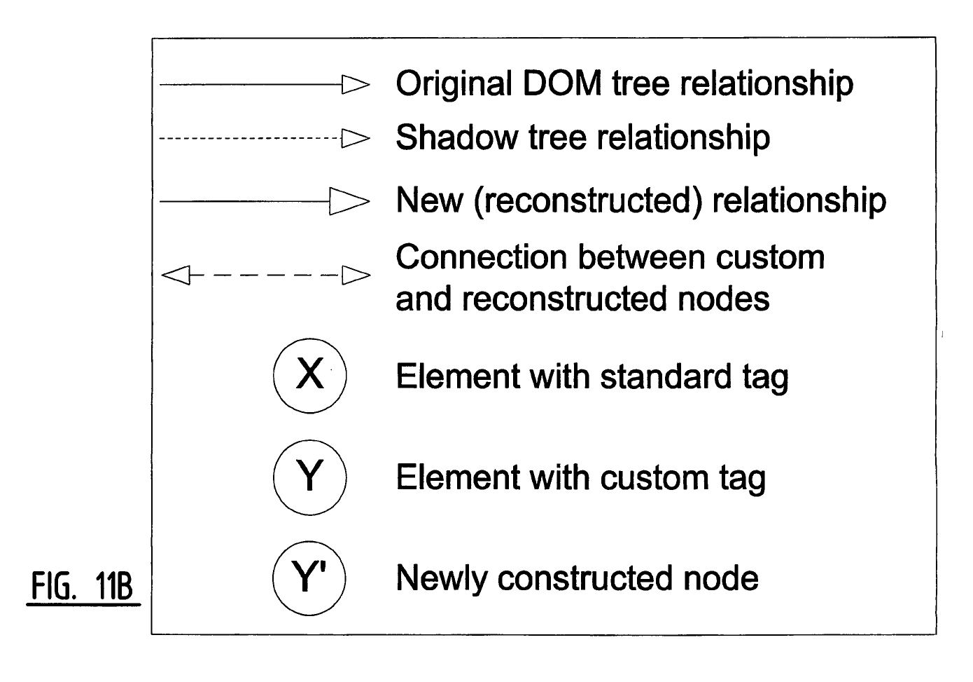

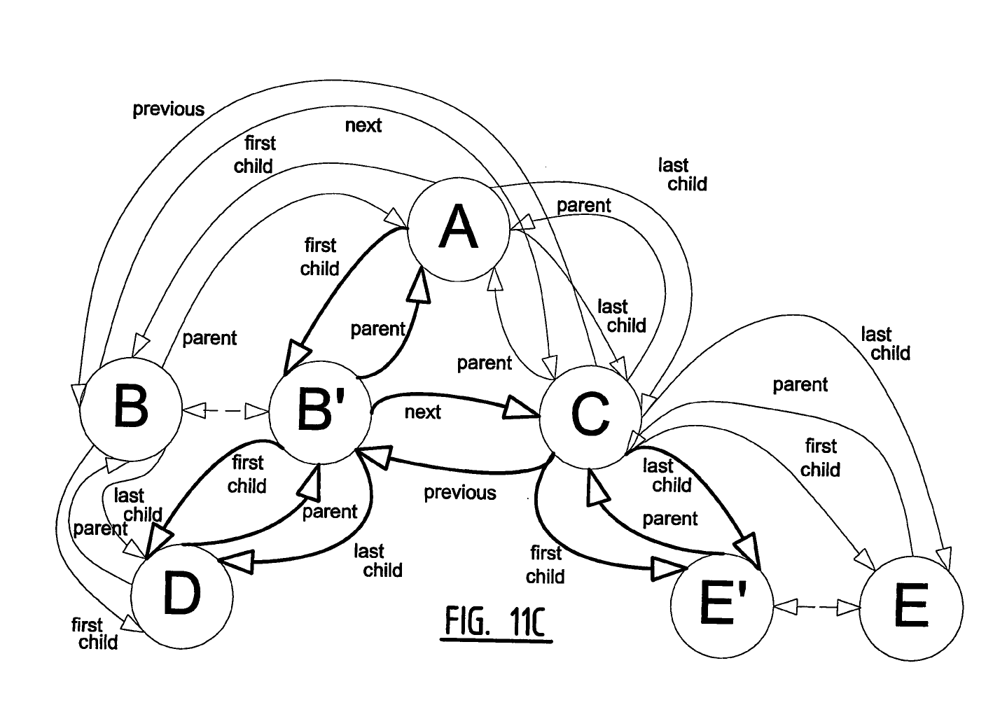

FIG. 11a shows another example of an original DOM tree, wherein nodes B and E have custom tags;

FIG. 11b shows the DOM tree of FIG. 11a after reconstruction, wherein the original tree structure is saved and the new nodes have been added.

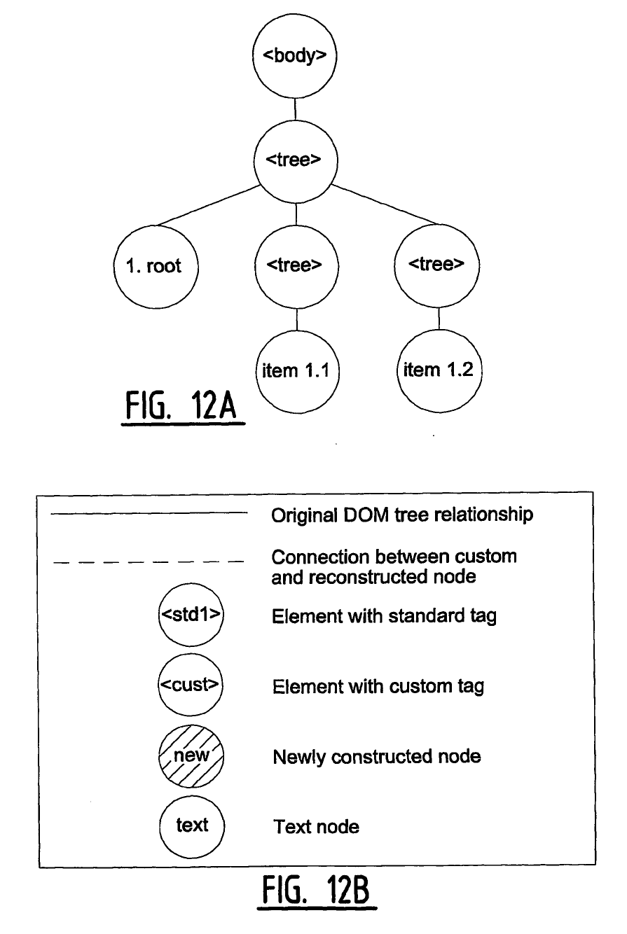

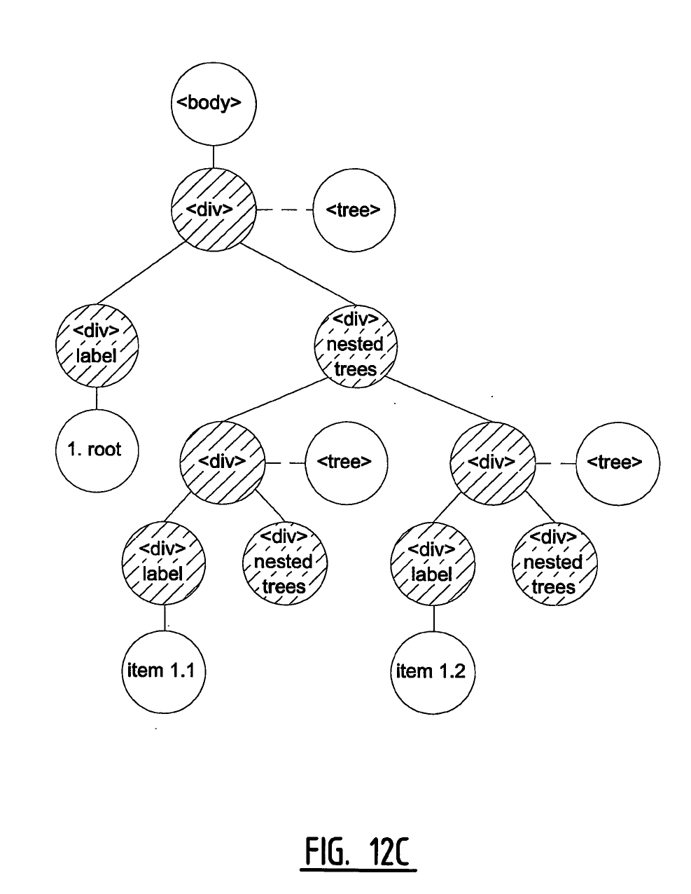

FIGS. 12a-12b show respectively the DOM tree before and after reconstruction for an example of (X)HTML code of annex 1;

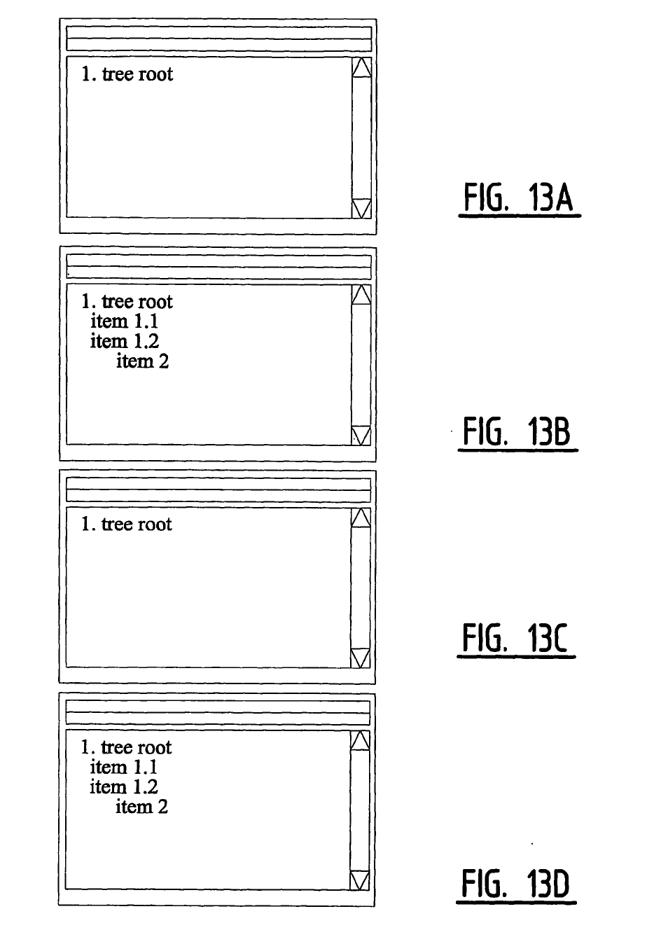

FIGS. 13a-d show screenshots of an example of code running on a first browser (Internet Explorer) and a second browser (Mozilla);

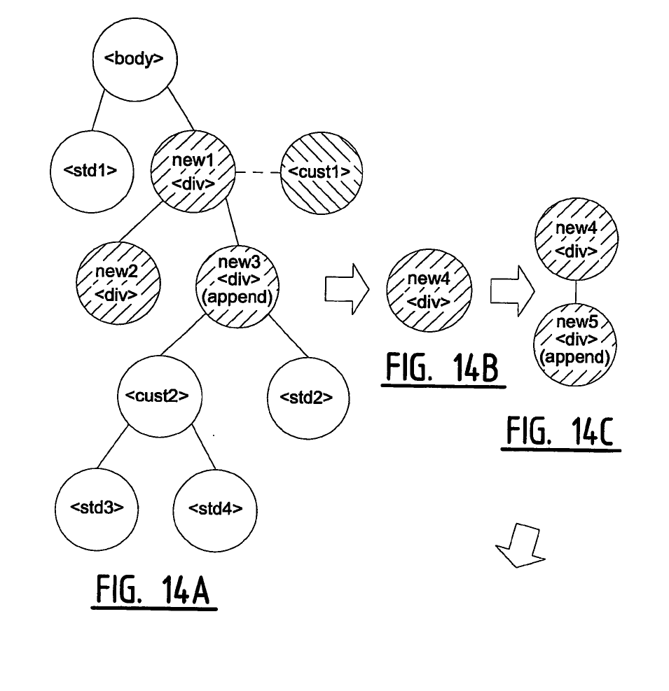

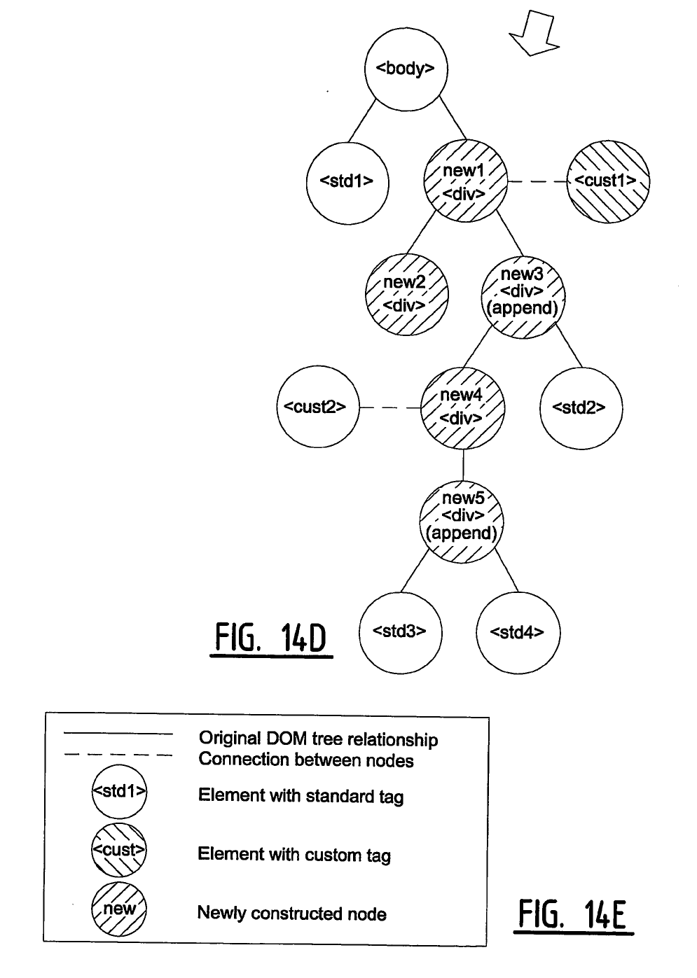

FIG. 14a is a schematic representation of an incompletely reconstructed DOM tree;

FIG. 14b is a schematic representation showing the creation of a new element;

FIG. 14c is a schematic representation showing the addition of extra nodes;

FIG. 14d is a schematic representation of a further reconstructed DOM tree;

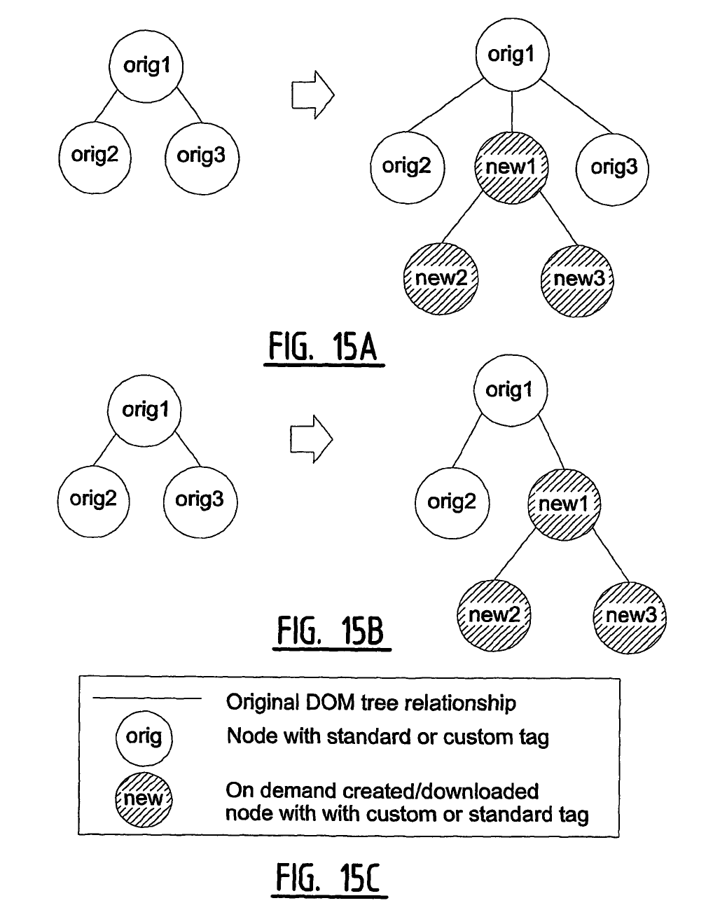

FIG. 15 is a schematic representation of the process of dynamically adding new nodes to an existing node in the DOM tree; and

FIG. 16 is a schematic representation of the process dynamically updating existing nodes of a DOM tree.

The invention provides a functional extension of an XML-based mark-up language with custom tag and attribute behaviours, implemented solely with standardised and thus commonly available features and technology. The invention facilitates the use of new tags within a predefined mark-up language, adds new attributes to existing tags, and controls the behaviour of standard tags and attributes in documents based on the XML standard, such as XHTML, without the use of any technology not available by default in the majority of modern web browsers.

The invention pertains to the process of the initial parsing and rendering of XML documents as well as the following process of the human-computer interaction with the user interface that may be described by such documents. Said processes may take place in any rendering computer program that supports ‘dynamic HTML’, for example modern web browsers such as Microsoft Internet Explorer, Netscape Communicator, Opera, Mozilla, including any browser applications based on the technology of these standard browsers, or so-called ‘derived browsers’.

As mentioned earlier the invention is a method, system and computer program that provides functional extension of the standard tags and attributes of an XML-based mark-up language with new, custom, behaviours for tags and attributes, its implementation depending solely on standardised and thus commonly available features and technology. This technology can be any XML rendering software or apparatus (“renderer”) that supports the Document Object Model (DOM) together with a scripting environment through which DOM data structures may be accessed and modified (such as JavaScript). Examples of computer programs incorporating such XML rendering software include Internet Explorer 5 and up, and Mozilla 1.1 and up.

The invention is not restricted to any existing rendering technology, but pertains to any future rendering software (based on currently existing technology or not) that supports the techniques used by the invention for handling custom tag and/or attribute behaviours.

For a user of the invention, for instance a website programmer or an application developer, the invention appears as what could be called a “horizontal extension” of (X)HTML, in that it both augments the functionality of existing tags as well as provides for new tags that realise new functionality within the domain of (X)HTML and/or XML-based mark-up languages. The invention requires no server technology to function, yet makes it possible to mix standard tags with new tags and optionally enhance the functionality of the attributes of existing tags.

Conventional HTML is oriented towards rendering documents. With DHTML, the combination of (X)HTML, Cascading Style Sheets (CSS) and Javascript, interactive documents can be used to form graphical user interfaces. This approach requires creating large portions of Javascript/VBscript code to control the interface's required interactivity. In practice, many approaches to creating DHTML user interface controls are characterised by relatively long development time, poor usability and reusability due to various reasons. The invention makes it possible to formalise DHTML by extending (X)HTML with tags and attributes that implement user interface controls. This way, user interfaces and their corresponding interaction model may be elegantly declared in a high-level mark-up language, instead of labour-intensive programming in languages such as Javascript or VBscript.

To said high-level user interface declaration, use of the invention requires no modification in existing infrastructure, either client-side or server-side. In fact, it solely depends on common functionality available in modern web browsers.

The Worldwide Web (WWW) refers to the collection of publicly accessible web servers on the Internet (FIG. 1). Individuals browsing the web contact these web servers through software called a browser (client), which facilitates communication between a personal computer (for instance) and a web server. This communication uses the HyperText Transfer Protocol, or HTTP. The actual data sent from server to client may be any media format, but the most common format is (X)HTML, an SGML-based mark-up language (FIG. 2).

A simplified view of the workings of a web client is shown in FIG. 2. Incoming documents are processed by the renderer, the central part of a web browser program. The renderer converts the document to a tree-shaped data structure that conforms to the Document Object Model standard (DOM) as specified by the World Wide Web Consortium (3WC). The contents of this data structure, or DOM tree, determine what is shown on, for instance, the computer screen or the printer. In modern browsers, all changes in the DOM tree are reflected to the screen output immediately.

Besides HTML, there exists a more recently introduced mark-up language called XML, which is more structured and—contrary to HTML—defines no presentation rules when used on its own. A further development is a mark-up language known as XHTML, which is an XML-based version of HTML and resembles HTML to a great extend, yet conforms to the stricter XML standard. HTML, XML and XHTML use tags and attributes as the main means to describe data. When, for instance, <img src=“http://www.w3.org/Icons/w3c main”/> is included in an XHTML document, this will cause an image to be included in the document. In this case, the tag is “img” and the attribute is “src”.

A DOM tree consists of nodes that have other nodes a their children. Nodes come in different types, the two most important ones being element and the text. Nodes of type element correspond to tags, type text nodes usually to the data between tags. FIGS. 3a and 3b show part of an example (X)HTML file together with its corresponding DOM tree (FIG. 3b), with two nodes of type text: “some text ” and “bold text”. FIG. 3c shows the underlying relationships in a DOM tree with more detail, with arrows for the node references to first child, last child, previous sibling, next sibling and parent.

FIG. 4a is an OMT model depicting one of the preferred embodiments of the invention. This model does not necessarily represent any actual implementation of the invention; it merely illustrates the nature and results of the invention according to the object-oriented paradigm. In this logical model, the invention may be identified as the BACKBASE Element class. As can be seen in FIG. 4a, one may think of all standard (X)HTML tags, such as <b> and <div>, to be derived from class DOM Element. In FIG. 4b, these tags now logically ‘inherit’ functionality from BACKBASE Element. So for instance, if an application of the invention implements drag-and-drop functionality by defining and implementing the behaviour of the tags ‘draggable’ and ‘dropreceiver’, DOM Elements corresponding to standard tags could, if attribute draggable was set to “yes”, be dragged and dropped into, say, a <div> element with attribute dropreceive set to true.

According to a preferred embodiment the method for the display of (X)HTML data is as follows:
1. The renderer fetches the XML data (“document”), for instance an XHTML file, from a file system or web server (FIG. 5) using standard means such as HTTP.
2.The renderer parses this document and creates a corresponding DOM tree that reflects the structure of the document.
3.During or after step (2), the renderer creates a representation of the DOM tree on its current output device, in most cases a computer screen. Unknown tags and/or attributes are ignored. However, they are represented in the document's DOM tree. Normally, the process stops at this point.

The DOM tree is preferably, but not necessarily, modified in a two-phase process (see also FIG. 6):
Phase 1: Build shadow tree phase. A secondary tree structure, the “shadow tree”, is created, in which the current (original) DOM structure is saved.
Phase 2: DOM tree reconstruction phase. The DOM tree is modified on a node-by-node basis by a) replacing certain elements with new nodes, and b) modifying certain properties of certain elements.

Although creating the shadow tree is not an absolute requirement for the invention to work, saving the composition of the DOM tree before modifying allows easy access to the original structure later. The shadow tree is created by saving the following properties (table 1) of every element in alternative data members:

TABLE 1
List of DOM element properties and corresponding
shadow tree properties

| DOM Element property | Shadow Tree property |
|---|---|
| firstchild | oFirst |
| lastChild | oLast |
| nextSibling | oNext |
| previousSibling | oPrev |
| parentNode | oParent |

In this embodiment the shadow tree is created by traversing the document's DOM tree node for node. FIGS. 7a-7c show how the original DOM tree relationships are saved in the shadow tree, and what the effect after reconstruction is. FIG. 8 describes the algorithm using a flow diagram:

1. The algorithm starts at the root node of a DOM tree, often the body of the document.

2. The five attributes listed in the table above are initialised with null values.

3. If the node has no child nodes, the process ends.

4. When a child node is added to its parent in the shadow tree, the parent's oFirst and oLast properties are updated as needed. Also, the oPrev, oNext and oParent properties of the child node and its siblings the shadow tree are updated as necessary.

5. For every child, a recursive call is made so that the algorithm may backtrack after having reached the leaves of a part of the DOM tree. (This step was introduced to make the flowchart clearer, but does not represent a favourable programming approach.)

6. If the type of the child node is not element, go to step 5 (text nodes, comment nodes etc. are skipped and do not form part the shadow tree).

7. The process continues at step 2 for the current child node.

The above method is further elucidated in FIGS. 7a-7c. FIG. 7a shows the original DOM tree. Node A has node B as only child. FIG. 7b shows the situation after step 1, just before reconstruction. The original tree relationships have been saved in the shadow tree. FIG. 7c shows the situation after step 2. Node B′ has replaced node B, while the original tree structure is still intact.

In the reconstruction phase of the DOM tree, the method traverses the DOM tree node for node. Starting for example from the DOM tree shown in FIG. 9a, when an element with a custom tag (“custom element”) is encountered, a new node is created (for example, a <div> element in FIG. 9b). Optionally, additional nodes (depending on the custom tag's implementation requirements) are added to this new node (two <div> elements in FIG. 9c; the one labelled “append”will serve to contain the custom element's children). The new node is inserted in the parent's children list immediately before the custom element (FIG. 9d). Afterwards, the element with the custom tag is removed from the DOM tree (FIG. 9d). FIG. 9e shows how the children of the custom element are moved to the new node (or to part of the subtree the new node is root of—the element labelled “append”in FIG. 9e). Finally, the new node and the custom element are mutually connected by giving each of them a property containing a reference to the other (cf. dotted line in FIG. 9e). This way, the original node and all its attributes or other data node remain accessible.

FIG. 10 provides a detailed description of the method for custom tag and custom attribute support. In this embodiment the method comprises the steps of:
1. The algorithm starts at the original root element (NODE) of a DOM tree, often the body of the document.
2. If the tag of NODE is not supported by the invention, jump to step 20.
3. A new node, called NEWNODE, mostly of type element, is created.
4. If no attributes (standard and/or custom) supplied for the node might affect NEWNODE and therefore need no processing, proceed to step 6.
5. Process NODE's attributes.
6. If no extra nodes (like the two elements in FIG. 9c) are needed, jump to step 9.
7. The extra nodes (which can themselves have child nodes) are created and added to NEWNODE.
8. One of the extra nodes, called APPENDNODE, is assigned to be the container of the original node's child nodes. (In some practical cases, this role may be assigned to various child nodes). Continue at step 10.
9. APPENDNODE is set to be the newly created node.
10. If the original node has no parent node, proceed to step 13.
11. NEWNODE is added to the original node's parent by inserting it immediately before (or after) NODE.
12.The original node is removed (disconnected) from its parent.
13. If NODE has no child nodes, continue at step 16.
14. Move the first (remaining) child node from the original node to APPENDNODE. Jump back to step 13.
15. Mutually connect NEWNODE and NODE to each other (i.e. both get an attribute that references the other).
16. If APPENDNODE has no child nodes (the original node would have had none either), the process exits. Otherwise, “children ” now denotes the APPENDNODE's child nodes.
17.For every child in “children”, a recursive call is made so that the algorithm may backtrack after having reached the leaves of a part of the DOM tree. (This step was introduced to make the flowchart clearer, but does not represent a favourable programming approach.)
18. If the type of the child node is not element, go to step 17 (text nodes, comment nodes etc. are skipped as they have no possible custom tag themselves nor have any children that might).
19. The process continues at step 2 for the current child node (NODE now refers to that child node).
20. If no attributes (standard and/or custom) supplied for NODE need processing, proceed to step 22.
21.Process NODE's attributes.
22.If NODE has no child nodes, the process exits. Otherwise, “children ” now denotes the NODE's child nodes; proceed at step 17.

The above method steps are further elucidated in FIGS. 11a and 11b For clarity, FIG. 11b shows a detailed view (including all relationships) of the combined result of step 1 and step 2 on the DOM tree shown in FIG. 11a.

Table 2 shows example (X)HTML source code that depends on the invention (referred to as ‘backbase_mini.js’) to implement the required functionality for the tree tag and the tooltip attribute. FIG. 12a depicts the DOM tree for this example (X)HTML code. In FIG. 12b the structure of the DOM tree after reconstruction is shown.

TABLE 2
Example of XHTML source code

<html xmlns:b=“http://www.backbase.com”>
<head>
<script type=“text/javascript”
src=“backbase_mini.js”></script>
</head>
<body onLoad=“MASTER_CONTROL_PROGRAM_INIT( );”>

<b:tree>

1. tree root
<b:tree tooltip=“item 1”>item

1.1</b:tree>

<b:tree tooltip=“item 2”>item

1.2</b:tree>

</b:tree>

</body>
</html>

Appendix 1 is a working minimal implementation of the invention that supports the tree tag and the tooltip attribute. The shadow tree phase is not implemented in this code. FIGS. 13a-13d show screenshots of Microsoft Internet Explorer and Mozilla running the code in table 2 and appendix 1. FIG. 13a shows a screenshot of an example of code running in the Internet Explorer browser. FIG. 13b shows a screenshot of the example of FIG. 13a, after clicking the “tree root ” and hovering over “item 1.2”. FIGS. 13c and 13d show corresponding screenshots if another web browser (Mozilla) is used.

Another preferred embodiment of the present invention is explained in FIGS. 14a-14d. In this embodiment only one of both custom elements (with a custom tag and/or a custom attribute) is replaced in the reconstructing phase. Only after a delay the remaining custom element(s) are reconstructed into their corresponding final standard elements. If we consider the example of FIG. 9d, we see that the first custom element <cust1> has been reconstructed. However, the second custom element <cust2>has not yet been reconstructed. For example, at start-up of the browser reconstructs the DOM tree by replacing the first custom element only. Only in a later stage when the reconstructed first custom element is activated, the DOM tree is restructured again by replacing the second custom element <cust2> by one or more standard elements, as is shown in FIGS. 14b-14d.

In a further preferred embodiment one or more new elements are added dynamically, i.e. at run time of the program, to an existing element. This is shown in FIG. 15 wherein new element <new> is added to the existing first element <orig1>. The new elements may be loaded by the renderer at any stage, i.e. at start-up and at-run time. The new elements may be standard elements or custom elements. In another preferred embodiment one or more existing elements can be replaced by one or more new (standard and/or custom) elements. This is for example shown in FIG. 16, wherein the existing third element <orig1>of the tree is replaced by a new node <new> that may provide a different behavior.

The present invention is not limited to the above-described preferred embodiments thereof; the rights sought are defined by the following claims, within the scope of which many modifications can be envisaged.

APPENDIX 1
function oBrowser( ) {

var sUA = navigator.userAgent.toLowerCase( );
this.ie = ((sUA.indexOf(‘msie’) != −1) &&

(sUA.indexOf(‘opera’) == −1)) ? true : false;

return this;

}
var oBrowser,oBody,oToolTipNode = null;
function MASTER_CONTROL_PROGRAM_INIT( ) {

oBrowser = new oBrowser( );
oBody = (oBrowser.ie && document.documentElement &&

document.body.clientHeight <= 20) ?

document.documentElement : oBody =

document.body;

DOM_Reconstruct(oBody,false);

}
function DOM_GetAtt(sAtt,oNode) { return oBrowser.ie ?
oNode[sAtt] : oNode.getAttribute(sAtt); }
function DOM_NormalizeTag(oNode) {

if (oBrowser.ie) var sTag = oNode.tagName;
else {

var sTag = oNode.nodeName.split(‘:’) [1];
if (!sTag) sTag = oNode.nodeName;

}
if (sTag) oNode.sTag = sTag.toUpperCase( );

}
function DOM_Reconstruct(oNode) {

DOM_NormalizeTag(oNode);
if (oNode.sTag == ‘TREE’) PARSE_TREE(oNode);
else {

oNode.oElm = oNode;
oNode.oElm.oNode = oNode;
DOM_ReconstructKids(oNode);

}
if (DOM_GetAtt(‘tooltip’,oNode)) EVENT_Add(oNode.oElm ?

oNode.oElm : oNode);
}
function DOM_ReconstructKids(oNode) {

for (var i = 0; i < oNode.childNodes.length; i++) {

var oKid = oNode.childNodes[i];
if (oKid.nodeType == 1) DOM_Reconstruct(oKid);

}

}
function BUILD_CreateReplaceElm(sTag,oNode) {

var oElm = document.createElement(sTag);
if (oNode.parentNode) {

oNode.parentNode.insertBefore(oElm,oNode);
oNode.parentNode.removeChild(oNode);

}
while (oNode.childNodes.length)

oElm.appendChild(oNode.childNodes[0]);

oElm.oNode = oNode;
oNode.oElm = oElm;
oElm.sTag = oNode.sTag;
return oElm;

}
function PARSE_TREE(oNode) {

var oElm = BUILD_CreateReplaceElm(‘DIV’,oNode);
oNode.oLabel = document.createElement(‘SPAN’);
oNode.oNestedTrees = document.createElement(‘DIV’);
oNode.oNestedTrees.style.paddingLeft = ‘10px’;
oNode.oNestedTrees.style.display = ‘none’;
while (oElm.childNodes.length) {

var oChildNode = oElm.childNodes[0];
DOM_NormalizeTag(oChildNode);
if (oChildNode.sTag == ‘TREE’)

oNode.oNestedTrees.appendChild(oChildNode)

else oNode.oLabel.appendChild(oChildNode);

}
oElm.appendChild(oNode.oLabel);
oElm.appendChild(oNode.oNestedTrees);
if (oNode.oNestedTrees.childNodes.length) {

oNode.oLabel.oNode = oNode;
oNode.oLabel.onclick = TREE_CLICK;

}
DOM_ReconstructKids(oNode.oLabel);

}
function TREE_CLICK(eEvent) {

var oNode = this.oNode;
if (!oNode.oNestedTrees.bRendered) {

for (var i = 0; i <

oNode.oNestedTrees.childNodes.length; i++)

DOM_Reconstruct(oNode.oNestedTrees.childNodes[i]);

oNode.oNestedTrees.bRendered = true;

}
if (oNode.oNestedTrees.childNodes.length) {

oNode.oNestedTrees.style.display = oNode.bOpen

? ‘none’ : ‘’;

oNode.bOpen = !oNode.bOpen;

}

}
function EVENT_Add(oElm) {

if (oBrowser.ie) {

oElm.onmouseover = EVENT_Over;
oElm.onmouseout = EVENT_Out;

} else {
oElm.addEventListener(‘mouseover’,EVENT_Over,false);
oElm.addEventListener(‘mouseout’,EVENT_Out,false);
}

}
function EVENT_FindNode(oElm)
{

var oNode = oElm.oNode;
if (!oNode) {

while (oElm.parentNode) {

oElm = oElm.parentNode;
if {oElm.oNode) break;

}
oNode = oElm.oNode;

}
return oNode;

}
function EVENT_Over(eEvent) {

var oElm = oBrowser.ie ? window.event.srcElement : this;
oNode = EVENT_FindNode(oElm);
if (DOM_GetAtt(‘tooltip’,oNode)) {

if (!oToolTipNode) {

oToolTipNode =

document.createElement(‘DIV’);

oToolTipNode.style.position =

‘absolute’;

oToolTipNode.style.backgroundColor =

‘#EEEEEE’;

oBody.appendChild(oToolTipNode);

}
oToolTipNode.innerHTML =

DOM_GetAtt(‘tooltip’,oNode);

oToolTipNode.style.left = _iMouseX + ‘px’;
oToolTipNode.style.top = _iMouseY + ‘px’;
oToolTipNode.style.display = ‘’;

}
if (!eEvent) eEvent = window.event;
if (eEvent.stopPropagation) eEvent.stopPropagation( );
else eEvent.cancelBubble = true;
return false;

}
function EVENT_Out(eEvent) {

var oElm = oBrowser.ie ? window.event.srcElement : this;
oNode = EVENT_FindNode(oElm);
if (DOM_GetAtt (‘tooltip’,oNode))

oToolTipNode.style.display = ‘none’;

if (!eEvent) eEvent = window.event;
if (eEvent.stopPropagation) eEvent.stopPropagation( );
else eEvent.cancelBubble = true;
return false;

}
var _iMouseX,_iMouseY;
function EVENT_MouseMove(eEvent) {

_iMouseX = (oBrowser.ie) ? event.x − 2 : eEvent.pageX;
_iMouseY = (oBrowser.ie) ? event.y − 2 : eEvent.pageY;

}
document.onmousemove = EVENT_MouseMove;

1. A method of rendering document data compliant with an XML-based mark-up language, comprising the steps of:
fetching the document data;
parsing the document data into a document object model (DOM) representation so as to provide a tree structure, comprising nodes representative of the document data elements including tags and/or attributes; characterized by
reconstructing the document object model (DOM) representation into a reconstructed document object model (DOM) representation by replacing the nodes of pre-specified elements of said document data elements by one or more nodes comprising standard XML compliant elements having standard tags and attributes so as to functionally extend said XML-compliant mark-up language;
rendering the document data with the reconstructed document object model (DOM) representation.

2. The methods according to claim 1, wherein the pre-specified elements are elements with standard tags and/or attributes providing a functionality, the pre-specified elements being replaced by standard XML compliant elements having one or more different tags and/or attributes providing a modified functionality.

3. The method according to claim 1, wherein the pre-specified elements are elements with custom tags and/or custom attributes, the pre-specified elements being replaced by standard XML compliant elements having standard tags and/or attributes.

4. The method according to claim 1, comprising the steps of:
reconstructing the document object model (DOM) representation by replacing a subset of the pre-specified elements of said document data elements by one or more nodes having standard XML compliant elements with standard tags and attributes;
rendering the document data with the reconstructed document object model (DOM); and
only upon triggering reconstructing the document object model (DOM) representation by replacing the remaining pre-specified elements of said document data elements by one or more nodes comprising standard XML compliant elements with standard tags and attributes.

5. The method according to claim 4, wherein triggering is caused during run-time by user action or an external event.

6. The method according to claim 1, wherein:
the parsing step comprises parsing the document data into a document object model (DOM) representation so as to provide a tree structure, comprising one or more nodes representative of standard XML compliant elements with standard tags and/or attributes and one or more nodes representative of custom elements with one or more custom tags and/or one or more custom attributes; and
the reconstructing step comprising reconstructing the document object model (DOM) representation by replacing the nodes of custom elements by one or more nodes comprising standard elements.

7. The method according to claim 1, wherein the step of reconstructing the document object model (DOM) representation comprises accessing and modifying the DOM representation data by executing program code, preferably script code.

8. The method according to claim 7, wherein a scripting language, for instance Javascript and/or VBScript, interpreter is applied to execute the script code.

9. The method according to claim 1, wherein the step of reconstructing the DOM representation comprises the steps of:
a) traversing the DOM representation node for node recursively;
b) upon detecting a node that is to be replaced:
b1) creating a new node of standard elements;
b2) optionally creating a subtree of one or more additional nodes by adding these additional nodes to the newly created node;
b3) inserting the new node and the additional nodes, if any, into the parents children list of the document object model (DOM) representation on a position immediately before or after the node representative of the node that is to be replaced;
b4) removing the node that is to be replaced from the document object model (DOM) representation;
b5) moving one or more children of the removed node that was to be replaced to the new node or to a preset additional node, if any, that is part of the subtree the new node is root of.

10. The method according to claim 9, comprising the step of mutually connecting the new node and said node that was to be replaced.

11. The method according to claim 10, wherein the step of connecting comprises providing both the node of the node that was to be replaced and the new node with an attribute containing a reference to one another.

12. The method according to claim 1, comprising after the step of parsing the document data into a document object model (DOM) representation the additional step of saving the current document object model (DOM) representation in a document object model (DOM) shadow representation.

13. The method according to claim 12, comprising saving the DOM element attributes first child, last child, next sibling, previous sibling, and parent node.

14. The method according to claim 12, comprising traversing the DOM representation node for node and saving the DOM representation into the DOM shadow representation, by
a) starting with some root node;
b) initializing at least the attributes representative of the first child node, the last child node, the next sibling node, the previous sibling node, and the parent node with predefined start values, preferably null values;
c) detecting if the node has a child node;
d) if the node has a child node, then add that child node to the node in the DOM shadow representation by updating the values of attributes firstChild and lastChild of the node and updating the values of attributes previousSibling, nextSibling and parentNode of the child node and, where necessary, its new siblings;
e) repeating steps b-d for every further child node.

15. The method according to claim 1, wherein the step of fetching the document data comprises fetching the data from a remote server.

16. The method according to claim 1, wherein the step of rendering the document data with the reconstructed document object model (DOM) representation is performed by a standard webbrowser, preferably Microsoft Internet Explorer 5.0, 5.5, 6.0 or higher, Mozilla 1.1 or higher, Netscape Communicator 7 or higher, Opera 7 or higher or Safari 1.1 or higher, including any webbrowser applications based on the technology of these standard browsers, or so-called ‘derived browsers’.

17. The method according to claim 1, comprising:
reconstructing the document object model (DOM) representation by replacing at least one node of a pre-specified element of said document data elements by one or more nodes with intermediate custom elements,
rendering the document data with the reconstructed document object model (DOM) using the at least one intermediate custom element; and
upon triggering the step of reconstructing the document object model (DOM) representation by replacing of the at least one node of the at least one intermediate custom element by one or more nodes comprising standard elements having standard tags and attributes.

18. The method according to claim 1, wherein the XML compliant document data is an XHTML-or HTML document or a document with a syntax that complies with any language derived from XHTML or HTML.

19. The method according to claim 1, comprising the step of dynamically adding one or more new elements to an existing element.

20. The method according to claim 1, comprising the step of dynamically replacing one or more existing elements by one or more new elements.

21. A device for rendering document data compliant with an extended XML-based mark-up language, the document data being stored on a remote server and accessible through a network, the device comprising:
an interface for retrieving the XML compliant document data from the server;
a parser for parsing the document data into a document object model (DOM) representation so as to provide a tree structure, comprising nodes representative of the document data elements including tags and/or attributes;
a reconstructor for reconstructing the document object model (DOM) representation into a reconstructed document object model (DOM) representation by replacing the nodes of pre-specified elements of said document data elements by one or more nodes comprising standard XML compliant elements having standard tags and attributes;
a renderer for rendering the document data with the reconstructed document object model (DOM) representation.

22. The device according to claim 21, wherein the pre-specified elements are elements with standard tags and/or attributes providing a functionality and the reconstructor is adapted so as to replace the pre-specified elements by standard XML compliant elements having one or more different tags and/or attributes providing a modified functionality.

23. The device according to claim 21, wherein the pre-specified elements are elements with custom tags and/or custom attributes and the reconstructor is adapted so as to replace the pre-specified elements by standard XML compliant elements having standard tags and/or attributes.

24. The device according to claim 21, wherein the reconstructor is adapted so as to perform the method steps of one of the claim 4.

25. A system for rendering XML compliant document data, comprising a host computer on which the XML compliant document data are stored, a client computer, and a network connecting the host computer and client computer, wherein the client computer comprises:
a network interface for retrieving the XML compliant document data from the host computer;
a parser for parsing the retrieved document data into an object model (DOM) representation so as to provide a tree structure, comprising nodes representative of the document data elements including tags and/or attributes;
a reconstructor for reconstructing the document object model (DOM) representation into a reconstructed document object model (DOM) representation by replacing the nodes of pre-specified elements of said document data elements by one or more nodes comprising standard XML compliant elements having standard tags and attributes;
a renderer for displaying the document data with the reconstructed document object model (DOM) representation.

26. The system according to claim 25, wherein the reconstructor and/or renderer are adapted so as to perform the method steps according to claim 1.

27. A device comprising a computer program product and at least one processor, the computer program product comprising instructions for causing the processor to execute the method steps of claim 1.

28. A data carrier containing a recorded computer program product upon whose execution by a processor the method according to claim 1 is carried out.

29. A computer program for carrying out, when run on a computer, the steps of any of the method claim 1.
